(19) United States
(12) Patent Application Publication
(10) Pub. No.: US 2019/0322828 A1
(43) Pub. Date: Oct. 24, 2019

(54) FOAM FROM INORGANIC PHYSICAL BLOWING AGENTS WITH IMPROVED PROPERTIES

(71) Applicant: E.I. DU PONT DE NEMOURS AND COMPANY, Wilmington, DE (US)

(72) Inventors: John P. Bishop, Wilmington, DE (US); David M. Dean, Wester Chester, PA (US); Erdogan Kiran, Blacksburg, VA (US)

(73) Assignee: E. I. DU PONT DE NEMOURS AND COMPANY, Wilmington, DE (US)

(21) Appl. No.: 16/348,683

(22) PCT Filed: Nov. 1, 2017
(86) PCT No.: PCT/US2017/059519

§ 371 Date: May 9, 2019

Related U.S. Application Data
(60) Provisional application No. 62/420,111, filed on Nov. 10, 2016.

(51) Int. Cl. C08J 9/00; C08J 9/12

(52) U.S. Cl. CPC C08J 9/0061; C08J 9/122; C08J 2333/10; C08J 2323/08; C08J 2331/04; C08J 2203/06

(57) ABSTRACT

The present invention relates to the field of foamable compositions having an ethylene-based co-polymer containing a carbon monoxide co-monomer.

### FIELD OF THE INVENTION

The present invention relates to foaming compositions having ethylene copolymers containing carbon monoxide (—CO) as a comonomer having improved foam properties.

### BACKGROUND OF THE INVENTION

Generally, there are two types of blowing agents used to make polymer foam: chemical blowing agents (CBAs) and physical blowing agents (PBAs). Chemical blowing agents decompose at elevated temperature to generate the gas used to foam the polymer. These CBAs have a relatively high cost, and have decomposition products that are undesirable. For example, the decomposition of one of the most common CBAs, azodicarbonamide, yields predominantly nitrogen, but also undesirable products such as carbon monoxide and ammonia. Physical blowing agents are liquids, gases, or supercritical fluids that are directly mixed with the polymer resin prior to foaming. In the past, common physical blowing agents have been chlorofluorocarbons (CFCs) and low-boiling point hydrocarbons such as isobutane. The environmental issues with CFCs are well-known, and use of low-boiling point hydrocarbons is a safety issue due to their flammability. The use of inert, inorganic physical blowing agents such as carbon dioxide and nitrogen (so-called “MuCell” process) is a relatively new and developing technology.

In the past, when using inert, inorganic physical blowing agents, solubility of the gas in the polymer is often a limiting factor, and this technology has really only been adopted for the production of moderate-to-high density foams. Production of low density foams utilize CBAs or low-boiling point hydrocarbons.

### SUMMARY OF THE INVENTION

Described herein are foaming compositions having ethylene copolymers containing carbon monoxide (—CO) as a comonomer, from inorganic physical blowing agents, which have improved foam properties, relative to ethylene copolymers that do not contain carbon monoxide.

In a first embodiment, the invention is directed to a foamable composition having an ethylene-based co-polymer containing a carbon monoxide co-monomer.

In another embodiment, the invention is directed to a method to prepare a foamable composition having an ethylene-based co-polymer containing a carbon monoxide co-monomer.

In yet another embodiment the invention is directed to

articles including the foamable composition according to the invention. In particular, the invention as a force absorption device in a variety of articles of manufacture.

### DETAILED EXPLANATION OF THE FIGURES

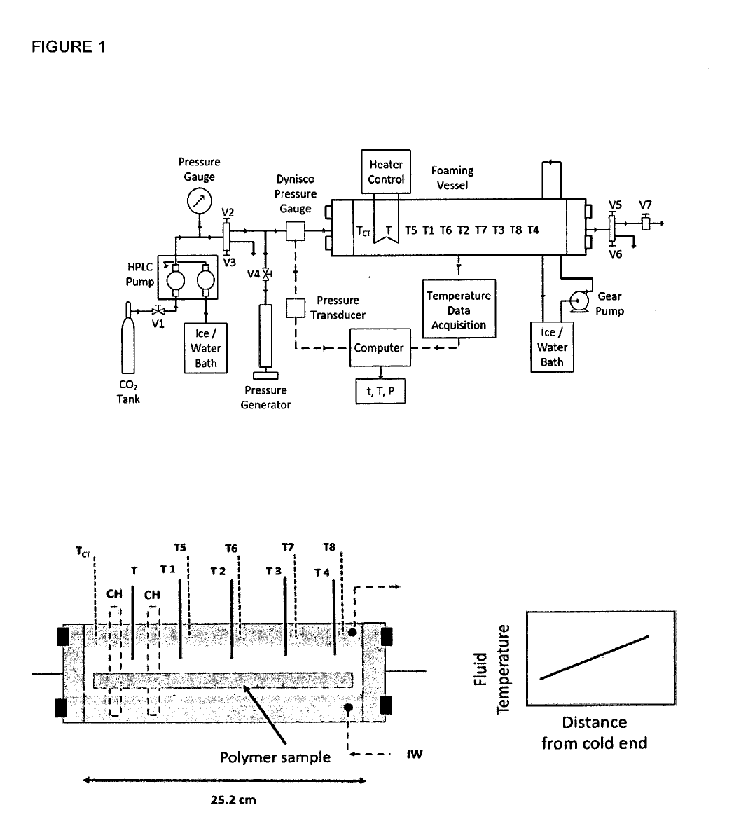

FIG. 1 is a schematic diagram of the gradient foaming system, [CH=cartridge heaters; T1-T8, thermocouples; T_{cT}=controller thermocouple; IW=ice water coolant circulation; V1-V7=valves);

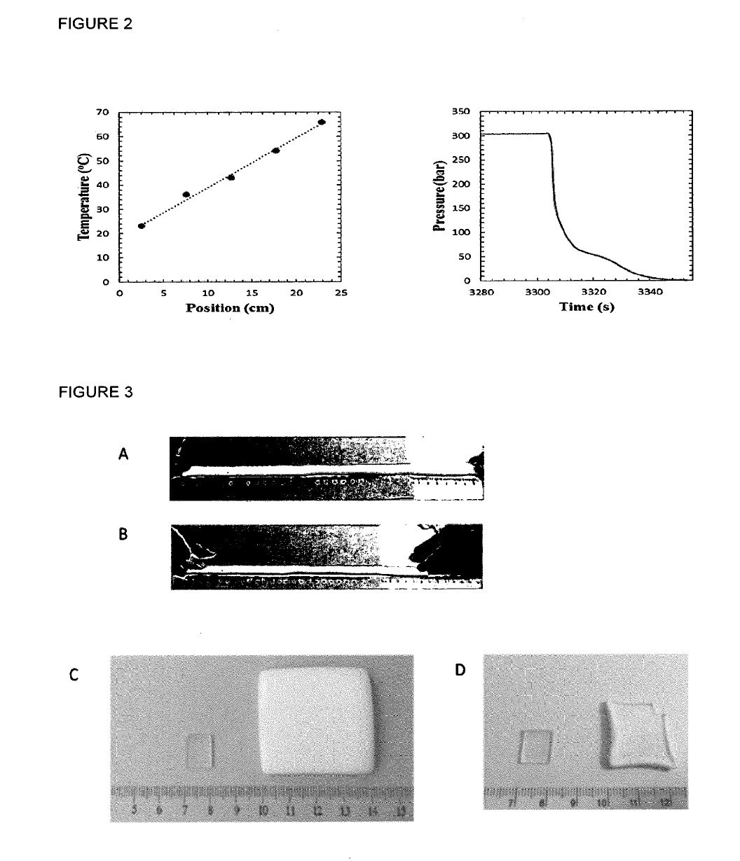

FIG. 2 illustrates a temperature gradient field in the foaming cell with the heated zone temperature set at 70° C. and pressure reduction path during decompression after exposure to 300 bar;

FIG. 3 illustrates properties of the foams of the present invention generated at 40° C./100 bar in the gradient foaming cell;

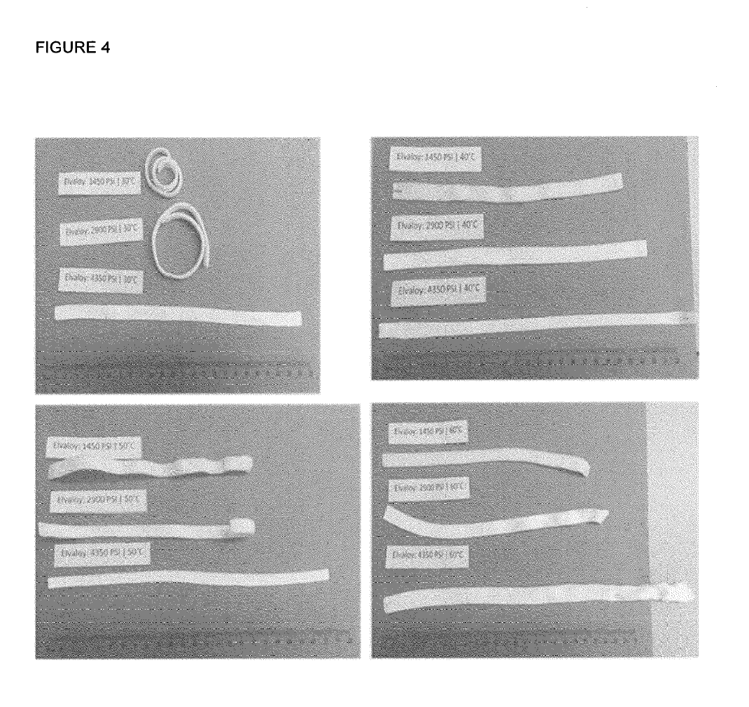

FIG. 4 illustrates foamed strips of the present invention under a temperature gradient with the foaming cell hot zone set at 30, 40, 50, and 60° C.;

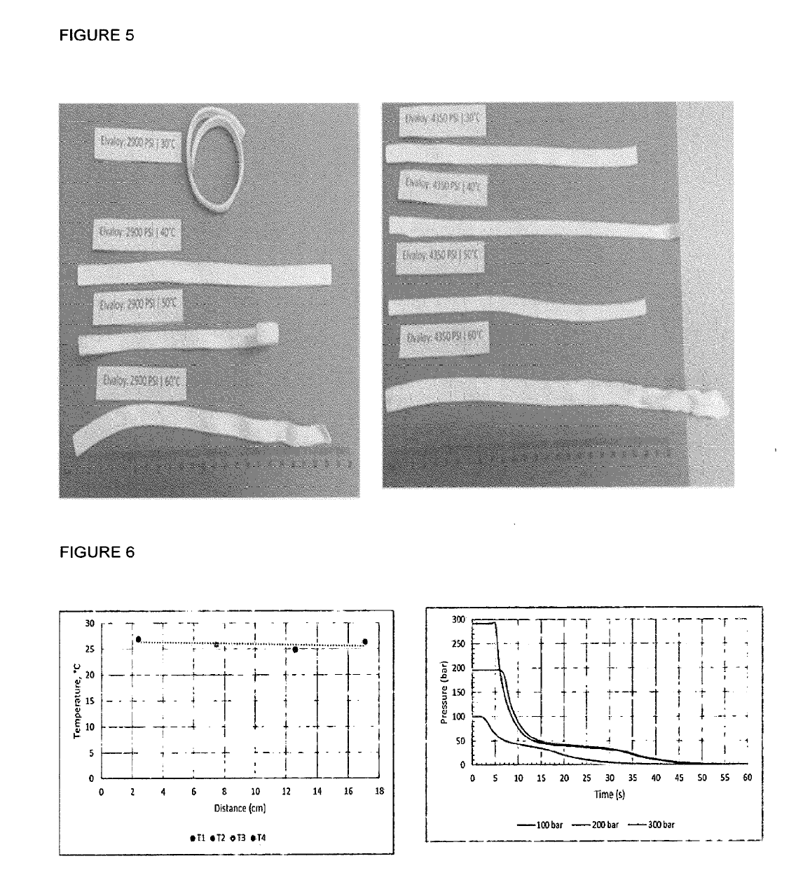

FIG. 5 illustrates a comparison of the foamed strips of the present invention under a temperature gradient with the foaming cell hot zone set at 30, 40, 50, and 60° C.;

FIG. 6 illustrates a temperature profile and pressure reduction history in foaming experiments with Poly(ethylene-co-vinyl acetate-co-carbon monoxide) at room temperature from 100, 200 and 300 bar saturation pressures; and

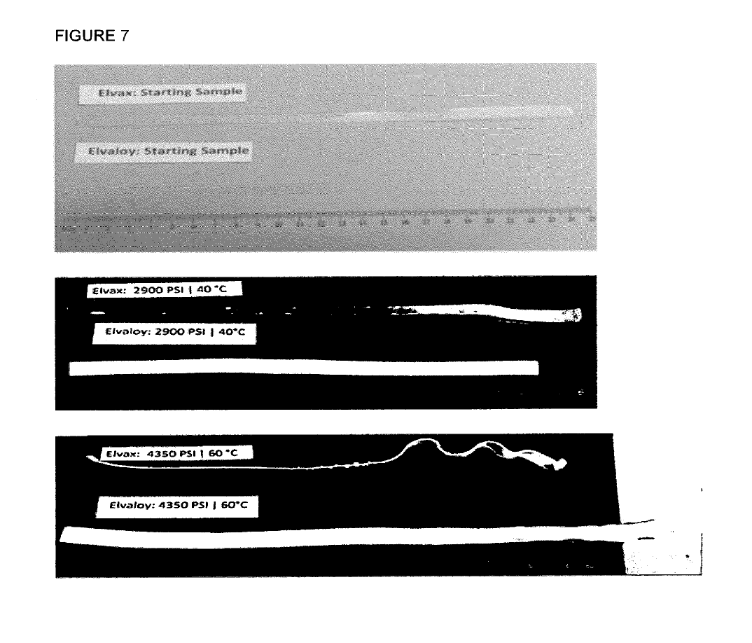

FIG. 7 is a comparison of ethylene-co-vinyl acetate and Poly(ethylene-co-vinly acetate-co-carbon monoxide) before and after foaming in carbon dioxide at 200 and 300 bar.

### DETAILED DESCRIPTION

### Definitions

As used herein, the term “a” refers to one as well as to at least one and is not an article that necessarily limits its referent noun to the singular.

As used herein, the terms “about” and “at or about” are intended to mean that the amount or value in question may be the value designated or some other value about the same. The phrase is intended to convey that similar values promote equivalent results or effects according to the invention.

As used herein, the term “terpolymer” means that the copolymer has three different comonomers.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 18 weight percent of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such. The term “copolymer” may refer to polymers that consist essentially of copolymerized units of two different monomers (a dipolymer), or that consist essentially of more than two different monomers (a terpolymer consisting essentially of three different comonomers, a tetrapolymer consisting essentially of four different comonomers, etc.).

The foaming compositions of the present invention which include ethylene copolymers containing carbon monoxide (—CO) as a comonomer, from inorganic physical blowing agents, have improved foam properties, relative to ethylene copolymers that do not contain carbon monoxide. More particularly, evidence provided herein illustrates carbon monoxide (CO) in the polymer backbone allows easier foaming and greater density reductions in a physical foaming process using carbon dioxide as the inorganic blowing agent.

Without being limited to any particularly theory, it is hypothesized that the polar—CO comonomer increases the solubility of the gas in the polymer, allowing for higher extents of weight reduction to be achieved. The presence of the CO monomer in the polymer backbone allows for increased solubility (or absorption) of carbon dioxide into the polymer, which thus allows for greater weight reductions to be achieved.

The foamable compositions of the present invention include ethylene-based terpolymers having the general formula E/X/CO, wherein E is an ethylene polymer, X is selected from the group including vinyl acetate or an acrylate co-monomer, and CO is a carbon monoxide co-monomer. Most commonly, the ethylene copolymer can contain vinyl acetate or any acrylate, including n-butyl acrylate that works as a co-monomer with carbon monoxide. More particularly, the ethylene copolymer can contain acrylate co-monomers (methyl acrylate, ethyl acrylate, iso-butyl acrylate) which work with CO. Suitable ethylene acid copolymers for use in the present invention are commercially available from E.I. du Pont de Nemours and Company of Wilmington, Del. (“DuPont”), under the trademark Elvaloy®.

Preferably, the ethylene-based co-polymer containing a carbon monoxide co-monomer is poly(ethylene-co-vinly acetate-co-carbon monoxide). The ethylene copolymers may be synthesized by any suitable polymerization process.

One of skill in the art would appreciate the scope of the present invention includes ethylene based co-polymer containing a CO-monomer blended with other polymers such as EVA, EMA, ionomers and polypropylene-based olefin block copolymers (OBCs) commercially available under the tradename INTUNE™ from Dow Chemical Company of Michigan (“DOW”).

The vinyl acetate or acrylate co-monomer has a range of 0 to 50.0 weight percent and preferably 0 to 35 weight percent, and most preferably 15.0 to 30 weight percent of the ethylene-based co-polymer containing a carbon monoxide co-monomer.

The carbon monoxide co-monomer has a range of 5.0 to 50.0 weight percent, and most preferably 5.0 to 15.0 weight percent of the ethylene-based co-polymer containing a carbon monoxide co-monomer.

In another embodiment the invention is direct to a process to make the ethylene-based co-polymer containing a carbon monoxide co-monomer. The process includes synthesizing the ethylene co-polymer containing —CO and foaming with a “supercritical” (PBA) blowing agent, most particularly, CO2 or Nitrogen, or mixtures thereof. The final foamed product has improved physical properties over foamable polymers which do not include —CO; as illustrated in the Examples and comparison studies provided herein.

### EXAMPLES

The examples illustrate the foamability of the terpolymer poly(ethylene-co-vinyl acetate-co-carbon monoxide).

Foaming experiments were conducted using only carbon dioxide as the foaming agent by absorption under pressure, followed by decompression. The experiments were conducted using extruded 1 mm thick sheets. A unique foaming cell, as illustrated in FIG. 1, with a temperature gradient field is employed which allows assessment of foaming at different temperatures at a given pressure. Experiments were conducted with a non —CO monomer in the polymer, ethylene-co-vinyl acetate, and a —CO container polymer poly(ethylene-co-vinly acetate-co-carbon monoxide), in sheet form, with sorption pressures at 100, 200 and 300 bar. With poly(ethylene-co-vinly acetate-co-carbon monoxide), experiments were conducted at elevated and room temperature (ambient) at these pressures. Comparison experiments were conducted with ethylene-co-vinyl acetate and poly(ethylene-co-vinly acetate-co-carbon monoxide).

It should be recognized based on the experiments that poly(ethylene-co-vinly acetate-co-carbon monoxide) can be foamed even at room temperature with initially very high expansion levels. After the recognized phenomenon of relaxation and shrinkage, Elvaloy foams display high density reductions which were in the range of about 79-89%. In contrast, the overall density reductions in foams of ethylene-co-vinyl acetate were in the range of about 45-68.

### Foaming of Ethylene-Co-Vinyl Acetate and Poly(Ethylene-Co-Vinly Acetate-Co-Carbon Monoxide) in Carbon Dioxide

### Experimental Foaming System

FIG. 1 is a schematic diagram of the foaming system. The cell is 25.2 cm long with an inside diameter of 1.9 cm. It is heated with cartridge heaters from one end, and can be cooled with ice-water circulation from the other end which generates a temperature gradient inside the tubular interior cavity. Temperatures at different positions are monitored in the metal body (designated as Thermocouples, T5, T6, T7 and T8) as well as inside the cavity (designated as Thermocouples, T1, T2, T3, and T4) with a set of dedicated thermocouples.

The polymer to be foamed is placed on a sample holder tray and positioned in the cell cavity, which is then charged with CO₂ to a desired pressure under a set temperature-gradient. The highest temperature (control temperature) is selected in consideration of the polymer properties (T_{g} and or Tₘ) so that at the pressures and temperatures employed CO₂ diffusion and dissolution in the polymer matrix would be achieved within a reasonable equilibration time, and that after decompression solidification can also be achieved to retain the foamed structure. Pressure reduction (decompression) path is also monitored. FIG. 2 illustrates a typical temperature profile when the cell is heated from one end. A typical pressure reduction path is also illustrated.

The samples from different section of the foamed polymer which represent different temperature zones can then be freeze-fractured in liquid nitrogen. In this way, by conducting an experiment just at one pressure, information on the foamability at a range of temperatures are generated.

### Poly(Ethylene-Co-Vinly Acetate-Co-Carbon Monoxide) Foams

The foaming experiments with poly(ethylene-co-vinly acetate-co-carbon monoxide) were conducted with shorter (12.5 cm) length strips due extreme expansion that this polymer displays upon foaming in CO₂. Foaming experiments were conducted with poly(ethylene-co-vinly acetate-co-carbon monoxide) under gradient with the heated zone at 30, 40, 50, and 60° C. at 100, 200 and 300 bar.

FIG. 3 illustrates this relaxation (shrinkage) phenomenon for the foam generated at 40° C./100 bar in the gradient foaming cell (A, immediately after foaming; and B, 5 minutes later). The rate of shrinkage however slows down with time, and typically levels of at 20-30% reduction level. FIG. 3 also illustrates a foam generated at 30° C./100 bar in a view-cell at immediately after foaming (C); and 20 hours later (D). Referring to FIG. 3C, an initial density reduction of 97% is illustrated.

FIG. 4 illustrates the foams of poly(ethylene-co-vinly acetate-co-carbon monoxide) after they reach their equilibrium dimensions. The foamed strips are under a temperature gradient with the foaming cell hot zone set at 30, 40, 50, and 60° C. (with the initially 12.5 cm long sample experiencing the temperature at 12.5 cm position in the cell cavity (see FIG. 1) as the hot zone after exposure to carbon dioxide at 100, 200 and 300 bar (1450, 2900, 4550 psi). As shown, at each temperature, the length of the foamed strip becomes longer with pressure.

FIG. 5 compares the foams at 200 bar and 300 bar at different temperatures. It is important to point out that the initial polymer strip being only 12.5 cm, it is positioned from the cold end of the foaming cell, and thus the warmer end of the polymer undergoes foaming at much lower temperatures than the set temperature for the heated end of the cell at 22.5 cm position (see FIG. 1). The initial unfoamed length being 12.5 cm, it is easy to appreciate the remarkably large expansion (typically nearly 100% and more) this polymer undergoes with foaming even at relatively low temperatures.

### Poly(Ethylene-Co-Vinly Acetate-Co-Carbon Monoxide) Foam Densities

Densities of the foams generated at different temperatures and pressures are shown in Tables 3 and 4. Expansions illustrated in FIG. 3 are corroborated with the large reductions observed in the densities. Even at these relatively low foaming temperatures, density reductions in the range of about 79 to 98% are observed. It should be further noted that these are the stabilized densities after the foams are removed and had undergone their relaxation process over several days.

Provided in Table 3 are foam densities of poly(ethylene-co-vinly acetate-co-carbon monoxide)—Hot zone under the T-gradient (Approximate highest temperatures experienced by the polymer are given in parentheses).

TABLE 3

| | | | % reduction in |
|---|---|---|---|
| | | | density |
| | | | compared to |
| Saturation | Temperature | Density | original |
| Pressure (bar) | (° C.) | (g/cm3) | polymer |
| Unfoamed | | 1.19 | NA |
| Original | | | |
| 100 | 30 (22° C.) | 0.25 | 79 |
| | 40 (22° C.) | 0.15 | 87 |
| | 50 (27° C.) | 0.23 | 80 |
| | 60 (28° C.) | 0.19 | 84 |
| 200 | 30 (23.5° C.) | 0.14 | 88 |
| | 40 (23° C.) | 0.15 | 87 |
| | 50 (27° C.) | 0.18 | 85 |
| | 60 (30° C.) | 0.14 | 88 |
| 300 | 30 (22.5° C.) | 0.19 | 84 |
| | 40 (22° C.) | 0.19 | 84 |
| | 50 (26° C.) | 0.18 | 85 |
| | 60 (25° C.) | 0.19 | 84 |

As provided in Table 4, the foam densities of poly(ethylene-co-vinly acetate-co-carbon monoxide)—cold zone under the T-gradient (Approximate temperatures experienced by the polymer given in parentheses).

TABLE 4

| | | | % reduction in |
|---|---|---|---|
| | | | density |
| | | | compared to |
| Saturation | Temperature | Density | original |
| Pressure (bar) | (° C.) | (g/cm3) | polymer |
| Unfoamed | | 1.19 | NA |
| Original | | | |
| 100 | 30 (16° C.) | 0.23 | 80 |
| | 40 (9° C.) | 0.20 | 83 |
| | 50 (11° C.) | 0.17 | 86 |
| | 60 (8° C.) | 0.16 | 87 |
| 200 | 30 (12° C.) | 0.16 | 86.5 |
| | 40 (9° C.) | 0.17 | 86 |
| | 50 (11° C.) | 0.17 | 86 |
| | 60 (9° C.) | 0.15 | 87 |
| 300 | 30 (10° C.) | 0.25 | 79 |
| | 40 (8° C.) | 0.19 | 84 |
| | 50 (8° C.) | 0.15 | 87 |
| | 60 (7° C.) | 0.13 | 89 |

### Room Temperature Foaming of Poly(Ethylene-Co-Vinly Acetate-Co-Carbon Monoxide) and Cell Densities

In view of the observations made from the gradient T runs which have demonstrated that —CO containing polymers of the present invention effectively foams in the temperature ranges from about 7-30 C at all pressures explored, experiments were also conducted at room temperature without heating or cooling imposed on the cell after saturation n ion carbon dioxide at 100, 200 and 300 bar. The temperature readings across the cell were 25° C. FIG. 6 illustrates the temperature profile and pressure reduction history in foaming experiments with Poly(ethylene-co-vinly acetate-co-carbon monoxide) at room temperature from 100, 200 and 300 bar saturation pressures, the temperature profile in the foaming cell, and the pressure reduction path from each saturation pressure during decompression.

The foam densities for these foams were also determined. They were essentially identical with a value of 0.2 g/cm³, respectively, corresponding to a density reduction of about 83%.

### Comparisons of Ethylene-Co-Vinyl Acetate and Poly(Ethylene-Co-Vinly Acetate-Co-Carbon Monoxide) Foams

FIG. 7 provides a visual comparison of the foams of ethylene-co-vinyl acetate and poly(ethylene-co-vinly acetate-co-carbon monoxide) for two foaming conditions. One of these refer to the foaming-cell high temperature having been set at 40° C. at saturation pressure at 200 bar; and the other being set 60° C. at saturation pressure of 300 bar. With poly(ethylene-co-vinly acetate-co-carbon monoxide) there is no blistering tendency which is observed with ethylene-co-vinyl acetate. poly(ethylene-co-vinly acetate-co-carbon monoxide) foams are soft and smooth. Compared to ethylene-co-vinyl acetate, poly(ethylene-co-vinly acetate-co-carbon monoxide) displays high degree of expansion with density reductions approaching 90% or higher. Further, poly(ethylene-co-vinly acetate-co-carbon monoxide) can be effectively foamed at room temperature. Comparison of Tables 2 and 5 indicate that pores that form in poly(ethylene-co-vinly acetate-co-carbon monoxide) are on the average larger than those in ethylene-co-vinyl acetate.

In FIG. 7, it is important to re-emphasize that the initial length of ethylene-co-vinyl acetate was 25 cm, in contrast to that of poly(ethylene-co-vinly acetate-co-carbon monoxide) which was 12.5 cm. It is important to recognize that the high-end temperatures in the gradient cell were set at 40 and 60 C, these correspond to lower temperatures (of 23 and 25 C) at the 12.5 cm position in the cell. Hence the foaming in poly(ethylene-co-vinly acetate-co-carbon monoxide) was actuality occurring at much lower temperatures. At these low temperatures, ethylene-co-vinyl acetate would not display foaming. It is appreciated that if the full 25 cm length of poly(ethylene-co-vinly acetate-co-carbon monoxide) were used, due to extreme expansion, the foamed polymer could not be removed from the cell without losing its integrity.

1. A foamable composition comprising an ethylene-based copolymer containing a carbon monoxide co-monomer.

2. The foamable composition of claim 1, wherein the ethylene-based co-polymer is a terpolymer having the formula E/X/CO, wherein E is an ethylene polymer, X is selected from the group comprising vinyl acetate or an acrylate co-monomer, and CO is a carbon monoxide co-monomer.

3. The foamable composition of claim 2, wherein the acrylate or vinyl acetate co-monomer has a range of 0 to 50.0 weight percent of the ethylene-based co-polymer containing a carbon monoxide co-monomer.

4. The foamable composition of claim 2, wherein the acrylate or vinyl acetate co-monomer has a range of 0 to 35.0 weight percent of the ethylene-based co-polymer containing a carbon monoxide co-monomer.

5. The foamable composition of claim 2, wherein the acrylate vinyl acetate co-monomer has a range of 15.0 to 30.0 weight percent of the ethylene-based co-polymer containing a carbon monoxide co-monomer.

6. The foamable composition of claim 2, wherein the acrylate co-monomer is selected from the group comprising, n-butyl acrylate, methyl acrylate, ethyl acrylate or iso-butyl acrylate.

7. The foamable composition of claim 3, wherein the carbon monoxide co-monomer has a range of 5.0 to 50.0 weight percent of the ethylene-based co-polymer containing a carbon monoxide co-monomer.

8. The foamable composition of claim 3, wherein the carbon monoxide co-monomer has a range of 5.0 to 15.0 weight percent of the ethylene-based co-polymer containing a carbon monoxide co-monomer.

9. The foamable composition of claim 2, wherein the ethylene-based co-polymer containing a carbon monoxide co-monomer is poly(ethylene-co-vinyl acetate-co-carbon monoxide).

10. The foamable composition of claim 9, wherein the ethylene-based co-polymer containing a carbon monoxide co-monomer, poly(ethylene-co-vinyl acetate-co-carbon monoxide) is about 10.0 weight percentage of the foamable composition.

11. A method to prepare a foamable composition comprising an ethylene-based co-polymer containing a carbon monoxide co-monomer comprising the steps of a. synthesizing the ethylene based compolymer of claim 7, b. charging a. with CO₂ to a desired pressure under a set temperature-gradient wherein the highest temperature (control temperature) is selected in consideration of the polymer properties (T_{g} and or Tₘ) so that at the pressures and temperatures employed CO₂ diffusion and dissolution in the polymer matrix would be achieved within a reasonable equilibration time, and that after decompression solidification can also be achieved to retain the foamed structure.

12. A foamable composition generated by the method of claim 11, wherein foaming occurs at 30° C./100 bar, wherein the foamable composition has a density reduction of about 97.0% immediately after foaming.

13. A foamable composition generated by the method of claim 11, wherein foaming occurs at ambient temperature/100 bar, wherein the foamable composition has a density reduction of about 83.0% immediately after foaming.

14. A foamable composition generated by the method of claim 11, wherein the blowing agents are selected from the group comprising CO₂, N₂ and a mixtures thereof.

15. An article comprising the foamable composition of claim 9 or a foam obtainable by foaming the composition of claim 9.

16. The article of claim 15, further comprising a non-foamable support.

17. The article of claim 15, wherein the non-foamable support defines a cavity, and at least a portion of the foamable composition or of the foam obtainable by foaming the composition is inside the cavity.

18. The article of claim 15, wherein the non-foamable support is packaging material.

19. The article of claim 15, wherein the non-foamable support is used in footwear.
